(19) United States
(12) Patent Application Publication
(10) Pub. No.: US 2006/0290133 A1
(43) Pub. Date: Dec. 28, 2006

(54) POSTBOUND ALBUM

(75) Inventor: Tanya R. Webb, Portland, OR (US)

Correspondence Address: KELLY LOWRY & KELLEY, LLP, 6320 CANOGA AVENUE, SUITE 1650, WOODLAND HILLS, CA, 91367, US

(73) Assignee: WESTRIM, INC., Van Nuys, CA (US)

(21) Appl. No.: 11/160,198

(22) Filed: Jun. 13, 2005

(51) Int. Cl. B42D 1/00

(52) U.S. Cl. 281/21.1

(57) ABSTRACT

A postbound album includes an inner spine assembly for receiving and supporting a plurality of album leaves or pages, wherein the inner spine assembly is removably mounted onto a selected album cover. The inner spine assembly includes a spine bracket of generally U-shaped cross section for receiving and supporting multiple album pages in a prescribed order, in combination with a double-ended post unit having elongated, forwardly projecting page posts extending slidably through opposed legs of the spine bracket and associated mounting apertures in the album pages to support and retain the album pages within the spine bracket. The post unit further includes relatively shorter, rearwardly projecting mounting posts for reception through associated mounting ports on the album cover, for removably securing the inner spine assembly and the album pages supported thereby relative to the album cover.

### BACKGROUND OF THE INVENTION

This invention relates generally to albums and album assemblies of the type having multiple album leaves or pages for use in supporting or displaying photographs and/or scrapbook items and the like. More particularly, this invention relates to an improved album having an inner spine assembly including a double-ended post unit for receiving, supporting and retaining multiple album pages in a prescribed order, and for quick and easy removable mounting within a selected album cover.

Postbound albums and the like are generally known in the art, wherein multiple upstanding post members are mounted at or adjacent an inboard side of the spine of an album cover at predetermined, spaced-apart locations suitable for receiving and supporting a plurality of album leaves or pages in a prescribed stacking order. In this regard, the album leaves or pages commonly incorporate spaced-apart mounting apertures formed near one marginal edge thereof at positions for slide-fit reception of the album post members therethrough. One or more suitable retainer elements such as flange-headed post screws or the like are secured to upper free ends of the post members to retain the album pages thereon.

Conventional postbound albums of the above-described type are not conducive to interchanging the assembled album pages from one album cover to another. That is, the post members are affixed to the album cover, whereby changeover of the album pages to another or alternative album cover requires individual removal of the album pages from one album cover and a corresponding individual mounting of those album pages onto upstanding post members associated with the new or replacement album cover. In this changeover process, the album pages can become disorganized, and/or items such as photographs and scrapbook mementos and the like carried by or mounted on the album pages can shift and fall out of place during handling.

There exists, therefore, a need for improvements in and to albums of the postbound type, particularly wherein a plurality of album leaves or pages are supported and retained in the desired assembled array for quick and easy removable mounting with respect to a selected one of a multiple different album covers. The present invention fulfills these needs and provides further related advantages.

### SUMMARY OF THE INVENTION

In accordance with the invention, an improved postbound album includes an inner spine assembly for receiving, supporting and retaining a plurality of album leaves or pages in assembled relation and in a prescribed order. The inner spine assembly is adapted for quick and easy mounting within a selected album cover, and for quick and easy removal therefrom for subsequent installation within a selected alternative or replacement album cover. Such removable mounting of the inner spine assembly occurs without requiring any of the assembled album pages to disturbed or otherwise removed from the inner spine assembly.

In the preferred form, the inner spine assembly comprises an elongated spine bracket of generally U-shaped cross section for receiving and supporting marginal edges of multiple album pages arranged or stacked in a prescribed order. The inner spine assembly further comprises a double-ended post unit having elongated, forwardly or upwardly projecting page posts carried by a common support plate and adapted to extend through opposed legs of the spine bracket and associated pre-formed mounting apertures positioned along the marginal edges of the album pages to support and retain the album pages within the spine bracket. Fastener means such as flange-headed post screws are threadably engaged with the upper or free ends of the page posts for retaining the assembled pages relative to the U-shaped spine bracket.

The double-ended post unit further includes relatively shorter mounting posts projecting rearwardly or downwardly from the support plate for reception through associated mounting ports formed on or in the album cover. Additional fastener means such as additional flange-headed post screws are threadably engaged with the lower or free ends of the mounting posts for removably retaining the U-shaped spine bracket and assembled pages carried thereby relative to the album cover.

In the preferred form, the album cover comprises front and rear cover leaves hingedly connected with or coupled to an intermediate cover spine, together with an internal flap on an inboard side of the rear cover leaf at a position generally adjacent or alongside the cover spine. This internal flap incorporates the mounting ports positioned for removable slide-fit reception of the mounting posts of the inner spine assembly.

Accordingly, the inner spine assembly including the album pages supported thereby can be mounted quickly and easily into a selected album cover by fitting the mounting posts through the flap mounting ports, and coupling the associated post screws thereto. The inner spine assembly can be removed quickly and easily by appropriate removal of the associated post screws, followed by similarly quick and easy installation onto a different album cover, all without disturbing the assembled album pages supported by the inner spine assembly.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a top perspective view of a postbound album constructed in accordance with the novel features of the invention, depicting an inner spine assembly removably supporting a plurality of album leaves or pages within an album cover;

FIG. 2 is a top perspective view of the postbound album of FIG. 1, and showing the album cover in an open position to reveal a front side of the inner spine assembly and album pages supported thereby;

FIG. 3 is top perspective view of the postbound album in an open position, similar to FIG. 1, but showing the album pages folded forwardly to reveal a rear side of the inner spine assembly;

FIG. 4 is an enlarged and partially exploded perspective view illustrating mounting of multiple album leaves or pages onto the inner spine assembly;

FIG. 5 is a further enlarged and partially exploded perspective view depicting removable mounting on the inner spine assembly onto the album cover;

FIG. 6 is a perspective view similar to FIG. 5, and showing the inner spine assembly mounted onto the album cover;

FIG. 7 is an exploded perspective view of a double-ended post unit of the inner spine assembly; and

FIG. 8 is an enlarged fragmented sectional view taken generally on the line 8-8 of FIG. 6.

### DETAILED DESCRIPTION OF THE PREFERRED EMBODIMENT

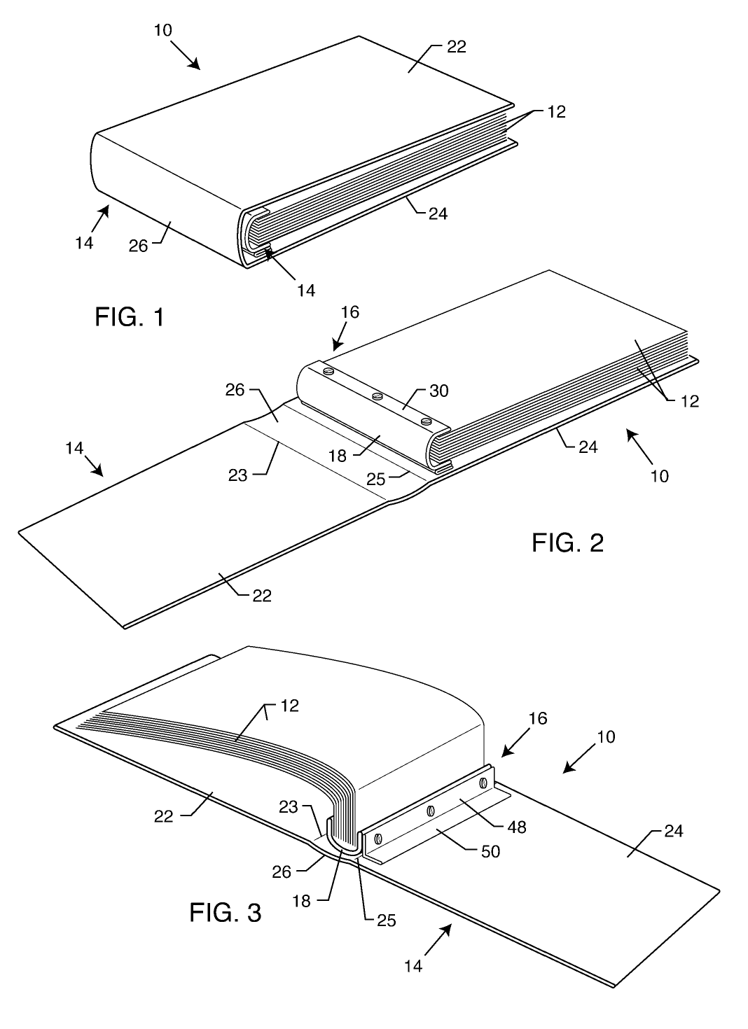

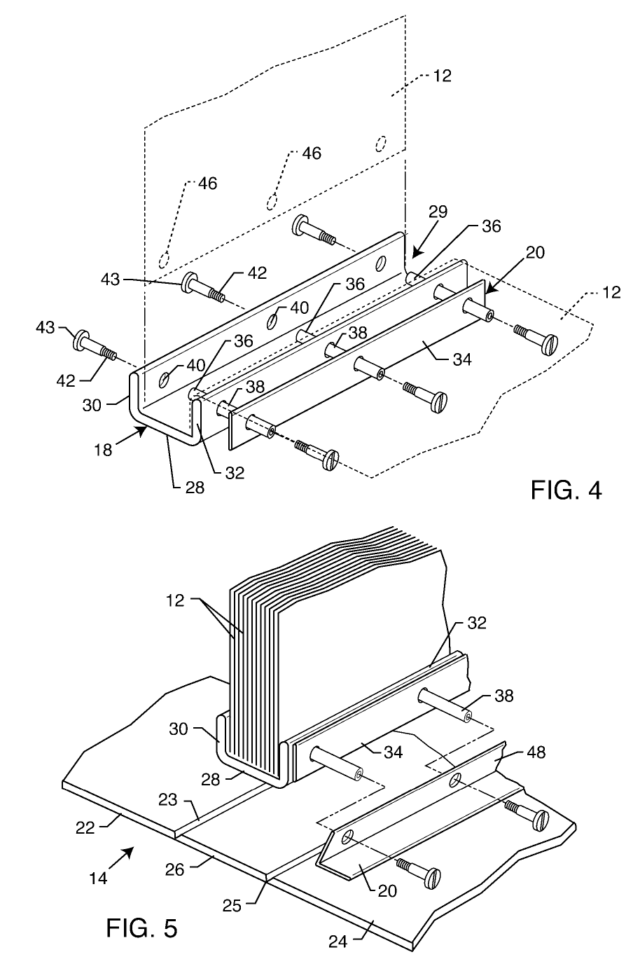

As shown in the exemplary drawings, an improved postbound album or album assembly referred to generally in FIGS. 1-3 by the reference numeral 10 is provided for supporting multiple album leaves or pages 12 in an assembled yet removably array within a selected album cover or binder 14. The postbound album 10 includes an inner spine assembly 16 (FIGS. 4-6) having a spine bracket 18 and a double-ended post unit 20 for removably supporting the album pages 12 within the album cover 14.

FIGS. 1-3 illustrate the postbound album 10 of the present invention in a fully assembled state, to include a plurality of a selected number of album leaves or pages 12 of the type used in a photograph album or scrapbook or the like, wherein these pages may be adapted to receive and support mementos such as photographs and scrapbook items, etc. (not shown). The album pages 12 are assembled in a stacked array, in a prescribed or predetermined sequential order, for binding or mounting within the album cover 14 which typically comprises relatively thick and stiff front and rear cover leaves 22 and 24 each hingedly connected at one marginal edge to an intermediate cover spine 26 by means of hinged margins 23 and 25, respectively. In accordance with the invention, the album pages 12 are supported and retained by the inner spine assembly 16 which is adapted for removable mounting to the cover 14, as will be described. Persons skilled in the art will recognize and appreciate that the album pages 12 may be loaded onto the inner spine assembly 16 prior or subsequent to mounting of the inner spine assembly 16 to the album cover 14.

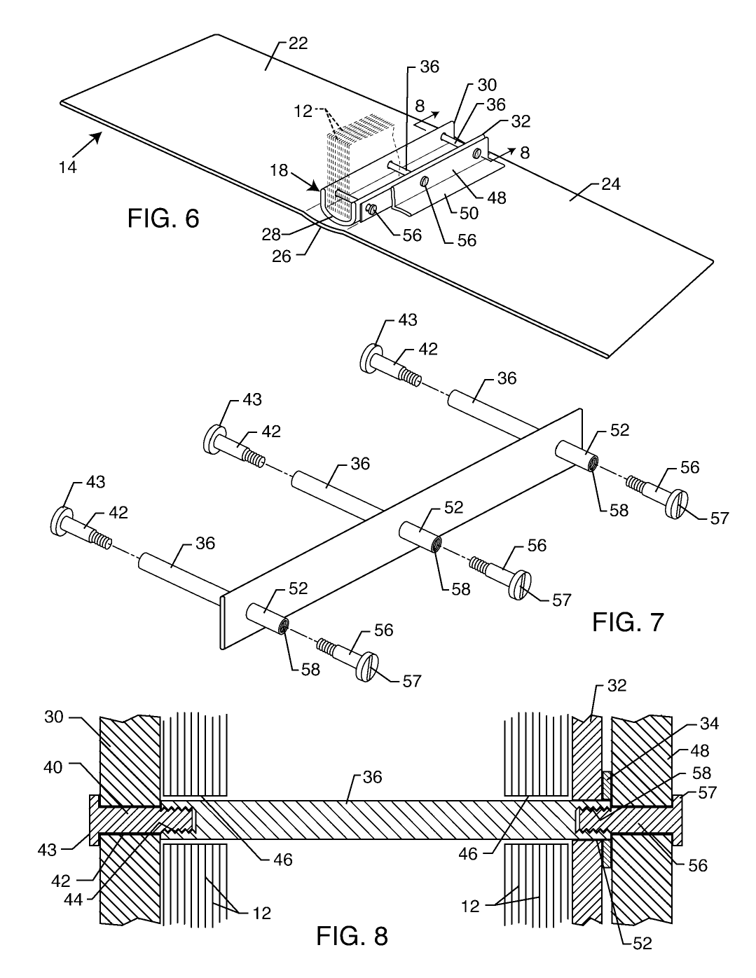

In the preferred embodiment of the invention as shown best in FIGS. 4-6, the inner spine assembly comprises the spine bracket 18 formed from a relatively stiff paperboard or molded plastic or similar material to have a generally U-shaped cross sectional configuration defining a central plate-like frame or frame member 28 joined along opposite side edges to a pair of legs 30 and 32. In one preferred form as shown, the spine member legs 30 and 32 extend from the frame 28 generally in a fixed or substantially inflexible, non-hinged parallel relation. In an alternative preferred form, the spine bracket legs 30 and 32 may be hingedly coupled to the frame 28. In either form, the frame 28 has a width generally conforming with the width of the album cover spine 26 for face-to-face abutted nested against an inboard side of the cover spine, whereas the two legs 30 and 32 extend from the frame 28 a sufficient distance to define an open-sided pocket or channel 29 therebetween (FIGS. 4 and 6) for receiving and supporting the marginal edges of a stack of album pages 12. FIGS. 1-3, and 5-6 show the spine bracket frame 28 seated or nested against the inboard side of the cover spine 26, with the leg 30 comprising a front leg positioned generally adjacent the hinged margin 23 between the cover spine 26 and the front cover leaf 22 of the album cover 14, and with the second leg 32 comprising a rear leg positioned generally adjacent the hinged margin 25 between the cover spine 26 and the rear cover leaf 24.

The double-ended post unit 20 of the inner spine assembly 16 comprises an elongated and relatively stiff or rigid support plate 34 formed from a suitable metal or plastic material, and having a size and shape to extend along one side of one of the spine bracket legs 30 and 32. The illustrative drawings show this support plate 34 fitted against an outboard side of the second or rear spine bracket leg 32. This support plate 34 supports at least one and preferably of plurality (as shown) of page posts 36 having a length sufficient to span the channel 29 between the two spine bracket legs 30, 32. More particularly, these page posts 36 extend from the support plate 34 through associated post ports 38 formed in the rear leg 32, to project across the inter-leg channel 29, and to define terminal or free ends aligned with or extending partially into corresponding associated fastener ports 40 formed in the other or front spine bracket leg 30. Fastener means such as post screws 42 having enlarged flanged heads 43 are fitted rearwardly through these fastener ports 40 and engaged with the free ends of the page posts 36, as by thread-in reception into internally threaded bores 44 as shown best in FIGS. 4 and 7-8. These post screws 42 may comprise shoulder screws as shown, and, when passed through the fastener ports 40 for threaded engagement with the page posts 36, the enlarged heads 43 thereof provide enlarged surface areas bearing against a front side of the leg 30 to support the page posts 36 spanning the channel 29 between the two legs 30, 32 in generally parallel spaced relation to the frame 28.

FIGS. 4-5 show loading of multiple album pages 12 into the inner spine assembly 16. As shown (FIG. 4), the support plate 34 of the double-ended post unit 20 is retracted a short distance from direct abutting engagement with the adjacent rear leg 32 of the spine bracket 18, thereby retracting the free ends of the page posts 36 a short distance from the associated fastener ports 40 formed in the other or front leg 30. In this orientation, multiple album pages 12 having page ports 46 (FIG. 4) preformed along one side margin thereof can be loaded individually or in groups into the spine bracket 18 and slidably assembled with the page posts 36 by fitting the page posts 36 through the page ports 46. When the album pages 12 are suitably assembled within the spine bracket 18 and onto the page posts 36, the support plate 34 can be advanced into abutting contact with the adjacent rear leg 32, to position the free ends of the page posts 36 generally at or partially within the fastener ports 40 formed in the front leg 30, whereupon the post screws 42 can be threadably assembled with the page posts 36 to retain the pages in the desired sequential order. Accordingly, the page posts 36 cooperate with the channel-forming legs 30, 32 and the post screws 42 to form a retaining means for supporting and retaining the multiple pages 12 in the desired sequential order within the spine bracket 18.

The inner spine assembly 16 with the thus-mounted album pages 12 carried thereby in a desired sequential order is adapted for removable mounting to the album cover 14. In the preferred form, a mounting flap 48 is hingedly coupled by means of a base strip 50 or the like to an inboard side of the rear cover leaf 24, at a position extending along the hinge line 25 between the rear cover leaf 24 and the cover spine 26. This mounting flap 48 has a plurality of pre-formed mounting ports 52 formed therein at positions for respective slide-fit reception of relatively short mounting posts 54 extending from the support plate 34 in a direction opposite to the page posts 36. In this regard, in the most preferred form of the invention, the mounting posts 54 respectively comprise in-line extensions of the associated page posts 36. Additional fastener means such as additional post screws 56 are fitted forwardly through the mounting ports 52 in the mounting flap 48 for threaded engagement into threaded bores 58 at the free ends of the mounting posts 52 to attach the inner spine assembly 16 in a removable manner to the album cover 14. In this regard, the post screws 56, which may also comprise shoulder screws as shown, include enlarged flanged heads 57 providing enlarged surface areas bearing against a rearward side of the mounting flap 48.

With this construction, the album pages 12 can be assembled with the inner spine assembly 16, in the manner previously described herein, before or subsequent to mounting of the inner spine assembly to the album cover 14 by means of the mounting flap 48 and associated post screws 56. If and when it is desired to remove the album pages 12 from the album cover, e.g., for mounting said album pages to a different album cover, the post screws 56 are quickly and easily removed from the associated mounting posts 54, to permit lift-away separation of the album pages 12 and the inner spine assembly 16. Importantly, the inner spine assembly 16 retains the album pages 12 in the desired assembled array and order, as a unitized subassembly, despite such removal from the album cover 14. The thus removed inner spine assembly 16 with the album pages 12 loaded therein can be quickly and easily re-assembled with a different or replacement album cover 14 in the same manner as described above.

A variety of further modifications and improvements in and to the identification postbound album 10 of the present invention will be apparent to persons skilled in the art. Accordingly, no limitation on the invention is intended by the foregoing description and accompanying drawings, except as set forth in the appended claims.

What is claimed is:

1. A postbound album, comprising:
an album cover including front and rear cover leaves each hingedly coupled to a cover spine;
an inner spine assembly for receiving and supporting multiple album pages in a predetermined sequential order, said inner spine assembly including an elongated spine bracket having first and second legs cooperatively defining an open-sided channel for receiving marginal edges of the multiple album pages;
said inner spine assembly further comprising a double-ended post unit including a support plate for bearing against an outboard side of said first leg, at least one page post carried by said support plate to extend through at least one corresponding post port formed in said first leg and to span said channel, and at least one mounting post carried by said support plate to extend therefrom in a direction opposite said at least one page post;
first fastener means for extending through at least one corresponding fastener port formed in said second leg into engagement with said at least one page post for retaining said at least one page post in a position spanning said channel with said at least one page post slidably fitting through at least one corresponding page port formed in each of the multiple album pages to retain the album pages within said channel; and
second fastener means for extending through at least one mounting port formed in said album cover into engagement with said at least one mounting post for removably mounting said inner spine assembly to said album cover.

2. The postbound album of claim 1 wherein said at least one page post comprises a plurality of pages posts, and further wherein said at least one mounting post comprises a plurality of mounting posts.

3. The postbound album of claim 1 wherein each of said at least one mounting posts comprises an extension of the corresponding one of said at least one page post.

4. The postbound album of claim 1 wherein said at least one page post defines an internally threaded free end, and further wherein said first fastener means comprises a post screw threadably engaged therewith.

5. The postbound album of claim 5 wherein said at least one post screw has an enlarged head defining an enlarged surface area for bearing engagement with said second leg.

6. The postbound album of claim 4 wherein said at least one mounting post defines an internally threaded free end, and further wherein said second fastener means comprises an additional post screw threadably engaged therewith.

7. The postbound album of claim 6 wherein said additional post screw has an enlarged head defining an enlarged surface area for bearing engagement with said album cover.

8. The postbound album of claim 1 wherein said at least one mounting post defines an internally threaded free end, and further wherein said second fastener means comprises a post screw threadably engaged therewith.

9. The postbound album of claim 1 wherein said spine bracket further comprises a frame member connected between said first and second legs, and cooperating therewith to define said open-sided channel.

10. The postbound album of claim 1 wherein said album cover further comprises a mounting flap having said at least one mounting port formed therein.

11. The postbound album of claim 10 wherein said mounting flap is connected to said rear cover leaf at a position generally adjacent said cover spine.

12. A postbound album, comprising:
an album cover;
an inner spine assembly including first means for receiving and supporting multiple album pages in a predetermined sequential order; and
second means for removably mounting said inner spine assembly to said album cover, said inner spine assembly being removable from said album cover while retaining the multiple album pages supported thereby in said predetermined sequential order.

13. A postbound album, comprising:
an album cover including front and rear cover leaves each hingedly coupled to a cover spine, and an internal flap at an inboard side of one of said front and rear cover leaves at a position generally adjacent said cover spine, said flap having a plurality of mounting ports formed therein;
an inner spine assembly for receiving and supporting multiple album pages in a predetermined sequential order, said inner spine assembly including an elongated spine bracket of generally U-shaped cross section and having space-apart first and second legs cooperatively defining an open-sided channel for receiving marginal edges of the multiple album pages, said first leg having a plurality of post ports formed therein, and said second leg having a plurality of fastener ports formed therein;
said inner spine assembly further comprising a double-ended post unit including a support plate for bearing against an outboard side of said first leg, a plurality of page posts carried by said support plate to extend respectively through said plurality of post ports formed in said first leg and to substantially span said channel between said first and second legs, and a plurality of mounting posts carried by said support plate to extend in a direction opposite said page posts and respectively at least partially into said mounting ports formed in said flap;
a plurality of first fasteners for extending respectively through said fastener ports formed in said second leg and into respective engagement with said page posts for retaining said page posts in a position spanning said channel, with said page posts slidably fitting respectively through a plurality of page ports formed in each of the multiple album pages to retain the album pages within said channel; and
a plurality of second fasteners for respectively engaging said mounting posts for removably mounting said inner spine assembly to said flap.

14. The postbound album of claim 13 wherein each of said page posts includes an internally threaded free end, and further wherein each of said first fasteners comprises a post screw adapted for threaded engagement therewith, each of said post screws including a flanged head defining an enlarged surface area for engaging an outboard side of said second leg.

15. The postbound album of claim 13 wherein each of said mounting posts includes an internally threaded free end, and further wherein each of said second fasteners comprises a post screw adapted for threaded engagement therewith, each of said post screws including a flanged head defining an enlarged surface area for engaging said flap at a side thereof opposite said inner spine assembly.

16. The postbound album of claim 13 wherein said flap is positioned at an inboard side of said rear cover leaf generally adjacent said cover spine, and further wherein said first leg of said spine bracket comprises a rear leg and said second leg of said spine bracket comprises a front leg.

17. The postbound album of claim 13 wherein said each of said page posts comprises an in-line extension of a corresponding one of said mounting posts.
